(19) United States
(12) Patent Application Publication
(10) Pub. No.: US 2002/0009186 A1
(43) Pub. Date: Jan. 24, 2002

(54) Method for call forwarding in a communications network

(76) Inventors: Ian Catley, Puchheim (DE); Martin Gartner, Taufkirchen (DE); Hans-Peter Vow Ow, Muenchen (DE); Stefan Honold, Muenchen (DE)

Correspondence Address: Bell, Boyd & Lloyd LLC, P.O. Box 1135, Chicago, IL, 60690, US

(21) Appl. No.: 09/825,084

(22) Filed: Apr. 2, 2001

(30) Foreign Application Priority Data
Mar. 31, 2000 (DE) 10016248.7

(51) Int. Cl. H04M 3/42

(52) U.S. Cl. 379/211.02

(57) ABSTRACT

A method for call forwarding in a communications network in which a single first subscriber line and at least one second subscriber line provided for a call transfer originating from the first subscriber line are assigned to a call acceptance group. A call made to the first subscriber line is forwarded within the call acceptance group to the second subscriber line and/or is signaled there for call answering.

### BACKGROUND OF THE INVENTION

1. Field of the Invention

The present invention relates to a method for call forwarding in a communications network wherein team functions encompassing multiple communications systems are provided.

2. Description of the Prior Art

Team functions are made available in a PABX system by setting up integrated executive-secretary systems. When setting up an integrated executive-secretary system, selected subscriber lines are combined to form an executive-secretary group which defines the role of the subscriber lines and specifies the relationships between the individual subscriber lines within the executive-secretary group. The definable roles are executive, secretary and assistant secretary. The relationships between the subscriber lines within an executive-secretary group are defined through allocation of an executive subscriber line to a secretary subscriber line or a secretary subscriber line to an assistant secretary subscriber line.

The Siemens Hicom communications system provides an integrated executive-secretary function with a maximum of four executive telephones and a maximum of two secretary telephones for each executive-secretary system (Hicom 300E V 2.0, Description of user facilities, Sect. 4.30 and Sect. 6.3.1, 23.04.1999, Siemens Part Number: P 31003-G1036-L100-3-18). A call made to an executive telephone is switched in a standard operating mode to a first secretary telephone and is signaled on the executive telephone and, where appropriate, on a further secretary telephone. The call can be answered by both the executive telephone and the further secretary telephone. Following call transfer to the executive telephone, a call made to the executive telephone is switched directly to the latter in a further operating mode and, where appropriate, is signaled on the secretary telephones. The relevant operating mode and the relevant call transfer are signaled on the executive telephone and the associated secretary telephones. The team function for an executive-secretary system has hitherto been available within one PABX system only.

An object of the present invention is to design a method for providing team functions encompassing multiple communications systems.

### SUMMARY OF THE INVENTION

Accordingly, the present invention is for a method for call forwarding in a communications network having a number of first and second subscriber lines, wherein a call made to a first subscriber line is switched in a first operating mode to the first subscriber line and is signaled on at least one selected second subscriber line for call answering, and a call made to a first subscriber line is switched in a second operating mode to a selected second subscriber line for call answering and is signaled on the first subscriber line and/or at least one further second subscriber line, the method including the steps of: assigning to a call acceptance group, both a single first subscriber line and at least one second subscriber line provided for a call transfer originating from the first subscriber line; and at least one of forwarding and signaling a call made to the first subscriber line within the call acceptance group to the second subscriber line.

A fundamental aspect of the method according to the present invention is that no hardware modifications are required for the provision of team functions encompassing multiple communications systems in communications networks in which the user facility of a network-wide call acceptance group is available. In a network-wide call acceptance group, a call made to a subscriber line of the call acceptance group is signaled in parallel to further subscriber lines which are assigned to the call acceptance group for call answering. In addition, the method according to the present invention offers the advantage that the restrictions in terms of the maximum number of executive subscriber lines and secretary subscriber lines for each executive-secretary system are lifted. This applies in particular to integrated executive-secretary systems which are set up to encompass multiple communications systems.

Additional features and advantages of the present invention are described in, and will be apparent from, the following Detailed Description of the Preferred Embodiments and the Drawings.

### DESCRIPTION OF THE DRAWINGS

FIG. 1 shows a communications network with a number of communications systems and a number of interrelated first and second subscriber lines.

### DETAILED DESCRIPTION OF THE PREFERRED EMBODIMENTS

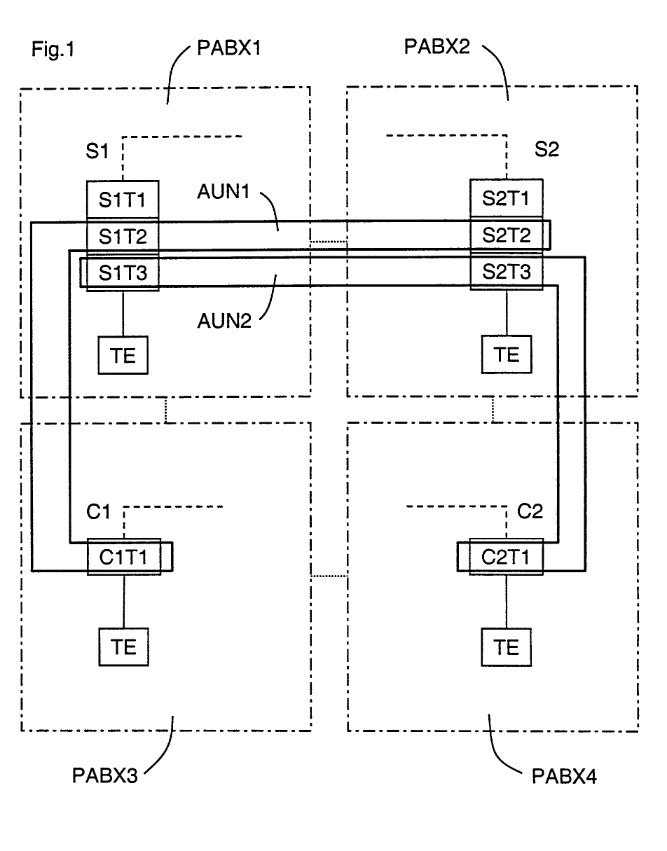

FIG. 1 shows a communications network with four PABX systems PABX1 to PABX4, two first subscriber lines C1T1 and C2T1 and a number of second subscriber lines S1T1 to S2T3. The first subscriber lines C1T1 and C2T1 are made available on executive workstations C1 and C2. A subscriber terminal device TE, on which a user interface is, in each case, made available for the use of team functions, is allocated to the first subscriber lines. The second subscriber lines S1T1 to S2T3 are assigned to two secretary workstations S1 and S2. A shared, team-function-supporting subscriber terminal device TE is assigned to the second subscriber lines S1T1 to S1T3, S2T1 to S2T3 on a secretary workstation S1. S2. The second subscriber lines S1T1 to S2T1 are set up, in each case, as main subscriber lines for the secretary workstations S1 and S2. The second subscriber lines S1T2, S1T3, S2T2 and S2T3 are set up in the present example as virtual subscriber lines which are provided for call transfer originating from the relevant executive workstation C1 and C2.

In the present case, the secretary workstations S1 and S2 and the executive workstations C1 and C2 are distributed among the four PABX systems PABX1 to PABX4. A call acceptance group AUN1 and AUN2 is, in each case, set up for each first subscriber line C1T1 and C2T1. In the example under consideration, an executive-secretary allocation is set up for the executive workstation C1 and the secretary workstations S1 and S2 and also for the executive workstation C2 and the secretary workstations S1 and S2. The first subscriber line C1T1 and the second subscriber lines S1T2 and S2T2 are therefore allocated to a call acceptance group AUN1 and the first subscriber line C2T1 and the second subscriber lines S1T3 and S2T3 are allocated to the call acceptance group AUN2.

If, for example, a call diversion is set up in a first operating mode from the first subscriber line C1T1 to the second subscriber line S1T2, a call made to the first subscriber line C1T1 is switched within the call acceptance group AUN1 to the selected second subscriber line S1T2 and is signaled in parallel on the first subscriber line C1T1 and on the further second subscriber line S2T2 for call answering. In a second operating mode, no call diversion takes place from the first subscriber line C1T1 to the second subscriber line S1T2, but rather a call made to the subscriber line C1T1 is switched directly to this subscriber line and is signaled in parallel within the call acceptance group AUN1 on the second subscriber lines S1T2 and S2T2 for call answering. In a corresponding manner, the call acceptance group AUN2 can be set up for a call diversion from the first subscriber line C2T1 to one of the two second subscriber lines S1T3 or S2T3. Within the call acceptance group AUN2, calls can be diverted or signaled in parallel in an analogous manner. The advantage of the described set-up of answering groups is that no subscriber on a further first subscriber line is disturbed by a call made to a first subscriber line.

A call made to the first subscriber line C1T1 or C2T1 is transferred in the first operating mode, following input of user information, to a second subscriber line S1T2, S1T3, S2T2 or S2T3, on which the call made to the first subscriber line C1T1 or C2T1 was signaled. A call diverted to the second subscriber line S1T2, S1T3, S2T2 or S2T3 is transferred in the second operating mode, following input of user information, to the associated first subscriber line C2T1 or C2T1. A call made to the first subscriber line C1T1 or C2T1 is advantageously diverted to the second subscriber line S1T2, S1T3, S2T2 or S2T3 on which corresponding user information was first entered.

The relevant operating mode is also advantageously signaled on the first subscriber lines C1T1, C2T1 and the second subscriber lines S1T2, S1T3, S2T2, S2T3.

Although the present invention has been described with reference to specific embodiments, those of skill in the art will recognize that changes may be made thereto without departing from the spirit and scope of the invention as set forth in the hereafter appended claims.

We claim as our invention

1. A method for call forwarding in a communications network having a plurality of first and second subscriber lines, wherein a call made to a first subscriber line is switched in a first operating mode to the first subscriber line and is signaled on at least one selected second subscriber line for call answering, and a call made to a first subscriber line is switched in a second operating mode to a selected second subscriber line for call answering and is signaled on at least one of the first subscriber line and at least one further second subscriber line, the method comprising the steps of:
assigning to a call acceptance group both a single first subscriber line and at least one second subscriber line provided for a call transfer originating from the first subscriber line; and
at least one of forwarding and signaling a call made to the first subscriber line within the call acceptance group to the second subscriber line.

2. A method for call forwarding in a communications network as claimed in claim 1, wherein a call acceptance group is set up for each first subscriber line.

3. A method for call forwarding in a communications network as claimed in claim 1, wherein the call acceptance group can be configured for use encompassing multiple communications systems.

4. A method for call forwarding in a communications network as claimed in claim 1, wherein the first and second operating modes are signaled on at least one of the first subscriber line and a second subscriber line.

5. A method for call forwarding in a communications network as claimed in claim 1, wherein a call made to a first subscriber line is transferred in the first operating mode, following input of user information, to the at least one further second subscriber line on which the call made to the first subscriber line was signaled, and a call diverted to a second subscriber line is picked up in the second operating mode, following input of user information, on an associated first subscriber line.

6. A method for call forwarding in a communications network as claimed in claim 1, wherein a call made to a first subscriber line is diverted to the second subscriber line on which corresponding user information was first entered.
